(19) United States
(12) Patent Application Publication
(10) Pub. No.: US 2025/0283189 A1
(43) Pub. Date: Sep. 11, 2025

(54) NON-ORIENTED ELECTRICAL STEEL SHEET AND METHOD FOR MANUFACTURING SAME

(71) Applicant: POSCO Co., Ltd, Pohang-si, Gyeongsangbuk-do (KR)

(72) Inventors: Jaehoon KIM, Pohang-si, Gyeongsangbuk-do (KR); Jooyoung KOO, Pohang-si, Gyeongsangbuk-do (KR); Seungil KIM, Pohang-si, Gyeongsangbuk-do (KR)

(73) Assignee: POSCO Co., Ltd, Pohang-si, Gyeongsangbuk-do (KR)

(21) Appl. No.: 18/268,425

(22) PCT Filed: Dec. 16, 2021
(86) PCT No.: PCT/KR2021/019219

§ 371 Date: Oct. 27, 2023

(30) Foreign Application Priority Data
Dec. 21, 2020 (KR) 10-2020-0179367

(51) Int. Cl. C21D 9/46; C21D 6/00; C21D 8/12; C22C 38/00; C22C 38/02; C22C 38/04; C22C 38/06; C22C 38/12; C22C 38/14; H01F 1/147

(52) U.S. Cl. CPC C21D 9/46; C21D 6/005; C21D 6/008; C21D 8/1205; C21D 8/1222; C21D 8/1233; C21D 8/1261; C22C 38/001; C22C 38/004; C22C 38/02; C22C 38/04; C22C 38/06; C22C 38/12; C22C 38/14; H01F 1/14791; C22C 2202/02

(57) ABSTRACT

A non-oriented electrical steel sheet according to an exemplary embodiment of the present invention contains, by wt %: 2.0 to 3.8% of Si, 0.1 to 2.5% of 0.0010 to 0.0050% of Nb, 0.0020 to 0.0060% of C, 0.0010 to 0.0050% of N, and a balance of Fe and inevitable impurities.

### TECHNICAL FIELD

An exemplary embodiment of the present invention relates to a non-oriented electrical steel sheet and a method for manufacturing the same. More particularly, an exemplary embodiment of the present invention relates to a non-oriented electrical steel sheet in which formation of fine carbonitrides is suppressed by appropriate addition of Mo, Ti, and Nb and bubbling in a molten steel manufacturing process, and a method for manufacturing the same. As a result, the present invention relates to a non-oriented electrical steel sheet having improved magnetization characteristics by facilitating movement of a magnetic domain wall through improvement of cleanliness in steel, and a method for manufacturing the same.

### BACKGROUND ART

Effective use of electric energy has become a big issue for improving the global environment such as energy saving, a reduction in fine dust generation, and a reduction in greenhouse gas. Since more than 50% of the entire electric energy that is currently being generated is consumed in an electric motor, high efficiency of the electric motor is indispensable to achieve high efficient use of electricity. Recently, in accordance with rapid development of the field of eco-friendly vehicles (hybrid vehicle, plug-in hybrid vehicle, electric vehicle, and fuel cell vehicle), an interest in high efficiency drive motor has rapidly increased, and high efficiency of high efficiency motors for home appliances and super-premium motors for heavy electric appliances has been recognized and government regulations have continued. Therefore, a demand for efficient use of electric energy is higher than ever.

On the other hand, in order to achieve high efficiency of the electric motor, an optimization is significantly important in all areas form selection of materials to design, assembly, and control. In particular, in terms of the material, magnetism characteristics of the electrical steel sheet are most important, and therefore, there is a high demand for low iron loss and high magnetic flux density. The high-frequency low iron loss properties are significantly important for drive motors of vehicles or motors of air conditioning compressors that should be driven not only in the power frequency region but also in the high frequency region. In order to obtain such high-frequency low iron loss properties, it is important to improve the initial magnetic permeability, which is an indispensable property to obtain high-frequency low iron loss because magnetization is fast even under a small magnetization force.

In a manufacturing process of such an electrical steel sheet, a large amount of resistivity elements such as Si, Al, and Mn should be added, and inclusions and fine precipitates present inside the steel sheet should be actively controlled to prevent these elements from interfering with the movement of the magnetic domain wall. However, in order to purify impurity elements such as C, S, N, Ti, Nb, and V in steelmaking to an extremely low level for controlling inclusions and fine precipitates, it is required to use high quality raw materials, and there is a problem that the productivity is reduced because secondary refining takes a long time. Accordingly, although studies on a method for adding a large amount of resistivity elements such as Si, Al, and Mn and control of impurity elements to an extremely low level have been conducted, substantial application results in this regard are insignificant.

### DISCLOSURE

### Technical Problem

An exemplary embodiment of the present invention provides a non-oriented electrical steel sheet and a method for manufacturing the same. More particularly, an exemplary embodiment of the present invention provides a non-oriented electrical steel sheet in which formation of fine carbonitrides is suppressed by appropriate addition of Mo, Ti, and Nb and bubbling in a molten steel manufacturing process, and a method for manufacturing the same.

### Technical Solution

An exemplary embodiment of the present invention provides a non-oriented electrical steel sheet containing, by wt %: 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities, wherein the non-oriented electrical steel sheet satisfies the following Expression 1.

$$0.02 \leq ( [ Ti ] + [ Nb ] ) \times [ Mo ] / ( [ C ] + [ N ] ) \leq 0.05 \qquad [ Expression 1 ]$$

(In Expression 1, [Ti], [Nb], [Mo], [C], and [N] represent contents (wt %) of Ti, Nb, Mo, C, and N, respectively.)

In the non-oriented electrical steel sheet according to an exemplary embodiment of the present invention, a density of one or more of carbides, nitrides, and carbonitrides having a particle diameter of 0.1 μm or less may be 100/mm² or less.

The total amount of Ti, Nb, C, and N may be 0.003 to 0.015 wt %.

The non-oriented electrical steel sheet according to an exemplary embodiment of the present invention may further contain one or more of 0.015 to 0.1 wt % of Sn, 0.015 to 0.1 wt % of Sb, and 0.005 to 0.05 wt % of P.

The non-oriented electrical steel sheet according to an exemplary embodiment of the present invention may further contain one or more of 0.01 wt % or less of Cu, 0.005 wt % or less of S, 0.002 wt % or less of B, 0.005 wt % or less of Mg, and 0.005 wt % or less of Zr.

The non-oriented electrical steel sheet according to an exemplary embodiment of the present invention may have a resistivity of 50 μΩ·cm or more.

The non-oriented electrical steel sheet according to an exemplary embodiment of the present invention may have an average grain diameter of 50 to 100 μm.

The non-oriented electrical steel sheet according to an exemplary embodiment of the present invention may have a magnetic permeability of 5,000 or more when measured at 30 A/m.

An exemplary embodiment of the present invention provides a method for manufacturing a non-oriented electrical steel sheet, the method including: manufacturing molten steel containing, by wt %, 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities, and satisfying the following Expression 1; bubbling the molten steel for 5 to 10 minutes; subjecting the molten steel to continuous casting to manufacture a slab; hot rolling the slab to manufacture a hot-rolled sheet; cold rolling the hot-rolled sheet to manufacture a cold-rolled sheet; and subjecting the cold-rolled sheet to final annealing.

$$0.02 \leq ( [ Ti ] + [ Nb ] ) \times [ Mo ] / ( [ C ] + [ N ] ) \leq 0.05 \qquad [ Expression 1 ]$$

(In Expression 1, [Ti], [Nb], [Mo], [C], and [N] represent contents (wt %) of Ti, Nb, Mo, C, and N, respectively.)

The bubbling may be performed using an inert gas at a flow rate of 5 Nm³ or more.

A grain growth calculated by the following Expression 2 may be 10 to 15.

$$Grain growth = Soaking temperature ( °C . ) in final annealing \times Soaking time ( min ) in final annealing / Average grain diameter ( μm ) \qquad [ Expression 2 ]$$

### Advantageous Effects

According to an exemplary embodiment of the present invention, as Mo is added at a certain ratio to Ti and Nb, formation of fine carbonitrides is suppressed to improve cleanliness in steel, such that movement of a magnetic domain wall is facilitated, thereby improving magnetization characteristics. Accordingly, the initial magnetic permeability is improved, and thus, the effect is excellent in iron loss in a high-frequency region. Therefore, a technology capable of manufacturing a non-oriented electrical steel sheet suitable for high-speed rotation is provided, which contributes to manufacturing motors for eco-friendly vehicles, motors for high efficiency home appliances, and super-premium electric motors.

### MODE FOR INVENTION

The terms “first”, “second”, “third”, and the like are used to describe various parts, components, regions, layers, and/or sections, but are not limited thereto. These terms are only used to differentiate a specific part, component, region, layer, or section from another part, component, region, layer, or section. Accordingly, a first part, component, region, layer, or section which will be described hereinafter may be referred to as a second part, component, region, layer, or section without departing from the scope of the present invention.

Terminologies used herein are to mention only a specific exemplary embodiment, and are not to limit the present invention. Singular forms used herein include plural forms as long as phrases do not clearly indicate an opposite meaning. The term “comprising” used in the specification concretely indicates specific properties, regions, integers, steps, operations, elements, and/or components, and is not to exclude the presence or addition of other specific properties, regions, integers, steps, operations, elements, and/or components.

When any part is positioned “on” or “above” another part, it means that the part may be directly on or above the other part or another part may be interposed therebetween. In contrast, when any part is positioned “directly on” another part, it means that there is no part interposed therebetween.

In addition, unless otherwise stated, % means wt %, and 1 ppm is 0.0001 wt %.

In an exemplary embodiment of the present invention, the meaning of “further containing an additional element” means that the additional element is substituted for a balance of iron (Fe) by the amount of additional element added.

Unless defined otherwise, all terms including technical terms and scientific terms used herein have the same meanings as understood by those skilled in the art to which the present invention pertains. Terms defined in a generally used dictionary are additionally interpreted as having the meanings matched to the related technical document and the currently disclosed contents, and are not interpreted as ideal or very formal meanings unless otherwise defined.

Hereinafter, exemplary embodiments of the present invention will be described in detail so that those skilled in the art to which the present invention pertains may easily practice the present invention. However, the present invention may be implemented in various different forms and is not limited to exemplary embodiments described herein.

A non-oriented electrical steel sheet according to an exemplary embodiment of the present invention contains, by wt %: 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities.

Hereinafter, the reason for limiting the components of the non-oriented electrical steel sheet will be described.

### Si: 2.00 to 3.80 wt %

Silicon (Si) serves to increase resistivity of a material to reduce iron loss. When the amount of Si added is too small, the iron loss improvement effect may be insufficient. When the amount of Si added is too large, hardness of the material increases, which may cause deterioration of productivity and punching properties. Therefore, Si may be contained in an amount of 2.0 to 3.8 wt %. More specifically, Si may be contained in an amount of 2.3 to 3.7 wt %. Still more specifically, Si may be contained in an amount of 3.5 to 3.3 wt %.

### Al: 0.10 to 2.50 wt %

Aluminum (Al) serves to increase the resistivity of the material to reduce iron loss. When the amount of Al added is too small, fine nitrides are formed, and an oxide layer of a surface part is not densely formed, and thus, it may be difficult to obtain a magnetism improvement effect. When the amount of Al added is too large, nitrides are excessively formed, which may cause deterioration of magnetism, and problems in all processes such as steelmaking and continuous casting occur, which may cause a significant deterioration of productivity. Therefore, Al may be contained in an amount of 0.1 to 2.5 wt %. More specifically, Al may be contained in an amount of 0.2 to 2.0 wt %. Still more specifically, Al may be contained in an amount of 0.5 to 1.5 wt %.

### Mn: 0.10 to 2.50 wt %

Manganese (Mn) serves to increase the resistivity of the material to improve iron loss and to form sulfides. When the amount of Mn added is too small, magnetism is deteriorated due to formation of fine MnS, and when the amount of Mn added is too large, formation of a {111} texture that is unfavorable for magnetism is promoted, and thus, a magnetic flux density is rapidly reduced. Therefore, Mn may be contained in an amount of 0.1 to 2.5 wt %. More specifically, Mn may be contained in an amount of 0.15 to 2.0 wt %. Still more specifically, Mn may be contained in an amount of 0.2 to 1.5 wt %.

### Mo: 0.010 to 0.080 wt %

Molybdenum (Mo) serves to suppress formation of (Nb, Ti) C, N by complete dissolution through a reaction with Nb and Ti, and to coarsen carbonitrides to reduce a distribution density. When the amount of Mo added is too small, the complete dissolution is not achieved, and thus, the ability to suppress formation of carbonitrides may decrease. When the amount of Mo added is too large, a Si compound is formed in the steel sheet, and a grain growth in the entire steel sheet is suppressed, which may cause deterioration of magnetism. Therefore, Mo may be contained in an amount of 0.01 to 0.08 wt %. More specifically, Mo may be contained in an amount of 0.02 to 0.07 wt %. Still more specifically, Mo may be contained in an amount of 0.03 to 0.05 wt %.

### Nb, Ti: 0.0010 to 0.0050 wt % each

Niobium (Nb) and titanium (Ti) combine with C and N to form fine carbides and nitrides, and thus the amount of each of Nb and Ti should be limited to 0.0050% or less. However, when Mo is added, Nb and Ti combine with Mo and are completely dissolved or exist in the form of coarse carbonitrides, resulting in their role in suppressing movement of a magnetic domain wall. In addition, when Mo is added, Nb or Ti needs to be contained in an amount of 0.0010 wt % or more to suppress formation of a Si compound. Therefore, each of Nb and Ti may be contained in an amount of 0.0010 to 0.0050 wt %. More specifically, each of Nb and Ti may be contained in an amount of 0.0015 to 0.0040 wt %. Still more specifically, each of Nb and Ti may be contained in an amount of 0.0020 to 0.0040 wt %.

### C: 0.0020 to 0.0060 wt %

Carbon (C) causes magnetic aging and combines with Ti, Nb, and the like to form carbides, resulting in deterioration of magnetic characteristics, and therefore, it is preferable that C is added as small as possible. However, in an exemplary embodiment of the present invention, formation of carbides is suppressed as much as possible through bubbling in a steelmaking process together with addition of Mo, and even when C is contained in an amount of 0.0020 wt % or more, the magnetism is not significantly affected. In order to manage the amount of carbon to less than 0.0020 wt %, an additional cost required for a decarburization process is too large, and an increase in cost may occur. Therefore, C may be contained in an amount of 0.0020 to 0.0060 wt %. More specifically, C may be contained in an amount of 0.0025 to 0.0050 wt %. Still more specifically, C may be contained in an amount of 0.0025 to 0.0040 wt %.

### N: 0.0010 to 0.0050 wt %

Nitrogen (N) forms fine AIN precipitates inside a base material and also forms fine nitrides by combination with Ti, Nb, and the like, and thus, the grain growth is suppressed, which causes deterioration of iron loss. Accordingly, it is preferable that the amount of N is as small as possible. However, in an exemplary embodiment of the present invention, formation of carbides is suppressed as much as possible through bubbling in a steelmaking process together with addition of Mo, and even when N is contained in an amount of 0.0010 wt % or more, the magnetism is not significantly affected. In order to manage the amount of nitrogen to less than 0.0010 wt %, costs required for managing the purity of molten ferroalloy, the purity of molten pig iron, and the like are too high, which may cause an increase in cost. Therefore, N may be contained in an amount of 0.0010 to 0.0050 wt %. More specifically, N may be contained in an amount of 0.0015 to 0.0045 wt %. Still more specifically, N may be contained in an amount of 0.0015 to 0.0040 wt %. 5

### Ti+Nb+C+N: 0.0030 to 0.0150 wt %

Mo reacts with Ti and Nb to be completely dissolved, and when the total amount of impurities such as Ti and Nb is too large, a bubbling time in steelmaking increases and productivity decreases. Therefore, an upper limit of the total amount may be limited to 0.015 wt %. Meanwhile, in order to suppress formation of an intermetallic compound by reaction of Mo with Si, a lower limit of the total amount may be limited to 0.003 wt %. More specifically, the total amount of Ti, Nb, C, and N may be 0.0050 to 0.0150 wt %.

The non-oriented electrical steel sheet according to an exemplary embodiment of the present invention may satisfy the following Expression 1.

$$0.02 \leq ( [ Ti ] + [ Nb ] ) \times [ Mo ] / ( [ C ] + [ N ] ) \leq 0.05 \qquad [ Expression 1 ]$$

(In Expression 1, [Ti], [Nb], [Mo], [C], and [N] represent contents (wt %) of Ti, Nb, Mo, C, and N, respectively.)

When Expression 1 is satisfied, formation of fine carbonitrides may be minimized. That is, within the range of 0.020 to 0.050, the formation of fine carbonitrides is suppressed and a distribution density of carbonitrides is minimized, and therefore, Expression 1 may be managed within this range. More specifically, the value of Expression 1 may be 0.030 to 0.060.

The non-oriented electrical steel sheet according to an exemplary embodiment of the present invention may further contain one or more of 0.015 to 0.1 wt % of Sn, 0.015 to 0.1 wt % of Sb, and 0.005 to 0.05 wt % of P.

### Sn, Sb: 0.015 to 0.100 wt % each

Tin (Sn) and antimony (Sn) segregate on a surface and grain boundaries of the steel sheet to suppress surface oxidation during annealing, inhibit diffusion of elements through the grain boundaries, and inhibit recrystallization of a {111}/ND orientation, thereby improving a texture. When the amount of Sn and Sb added is too small, the effects described above may not be sufficient. When the amount of Sn and Sb added is too large, toughness is deteriorated due to an increase in grain boundary segregation amount, and thus, productivity may be deteriorated compared to magnetism improvement. Therefore, each of Sn and Sb may be further contained in an amount of 0.015 to 0.100 wt %. More specifically, each of Sn and Sb may be further contained in an amount of 0.020 to 0.075 wt %.

### P: 0.005 to 0.050 wt %

Phosphorus (P) segregates on the surface and grain boundaries of the steel sheet to suppress surface oxidation during annealing, inhibit diffusion of elements through the grain boundaries, and inhibit recrystallization of a {111}/ND orientation, thereby improving a texture. When the amount of P added is too small, the effects thereof may not be sufficient. When the amount of P added is too large, hot workability is deteriorated, and thus, productivity may be deteriorated compared to magnetism improvement. Therefore, P may be further contained in an amount of 0.005 to 0.050 wt %. More specifically, P may be further contained in an amount of 0.007 to 0.045 wt %.

The non-oriented electrical steel sheet according to an exemplary embodiment of the present invention may further contain one or more of 0.01 wt % or less of Cu, 0.005 wt % or less of S, 0.002 wt % or less of B, 0.005 wt % or less of Mg, and 0.005 wt % or less of Zr.

### Cu: 0.01 wt % or Less

Copper (Cu) is an element that may form sulfides at a high temperature, and is an element that causes defects in a surface part during manufacture of a slab when added in a large amount. Therefore, when Cu is further contained, Cu may be contained in an amount of 0.01 wt % or less. More specifically, Cu may be contained in an amount of 0.001 to 0.01 wt %.

### S: 0.005 wt % or Less

Sulfur (S) forms MnS, CuS, and (Mn, Cu)S, which are fine precipitates, which deteriorates magnetic characteristics and deteriorates hot workability, and therefore, it is preferable that S is managed as small as possible. Therefore, when S is further contained, S may be contained in an amount of 0.005 wt % or less. More specifically, S may be contained in an amount of 0.0001 to 0.005 wt %. Still more specifically, S may be contained in an amount of 0.0005 to 0.0035 wt %.

### B: 0.002 wt % or Less, Mg: 0.005 wt % or Less, and Zr: 0.005 wt % or Less

B, Mg, and Zr are elements that adversely affect magnetism, and each of B, Mg, and Zr may be further contained within the above range.

The balance contains Fe and inevitable impurities. The inevitable impurities are impurities to be incorporated in the steelmaking process and the manufacturing process of the oriented electrical steel sheet and are well known in the art, and thus, a specific description thereof will be omitted. In an exemplary embodiment of the present invention, the addition of elements other than the alloy components described above is not excluded, and various elements may be contained within a range in which the technical spirit of the present invention is not impaired. In a case where additional elements are further contained, these additional elements are contained by replacing the balance of Fe.

In the non-oriented electrical steel sheet according to an exemplary embodiment of the present invention, a density of one or more of carbides, nitrides, and carbonitrides having a particle diameter of 0.1 μm or less may be 100/mm² or less.

In an exemplary embodiment of the present invention, a certain content of Ti, Nb, C, and N is contained, Mo is added in an appropriate amount relative to a content of Ti and Nb, and Mo is completely dissolved by a reaction with Nb and Ti through bubbling in the steelmaking process, such that a density of carbides, nitrides, or carbonitrides (hereinafter, also referred to collectively as “carbonitrides”) may be reduced as much as possible. A lower limit of a particle diameter of carbonitride may be 0.02 μm. Carbide having a particle diameter smaller than the above particle diameter may have no substantial effect on magnetism. The particle diameter may refer to a particle diameter of a circle assuming a virtual circle having the same area as the area of carbonitride when observing the steel sheet. A measurement plane of the carbonitride may be a cross section (TD plane) in a direction perpendicular to a rolled direction. The carbonitride may be observed using a scanning electron microscope (SEM).

A density of carbonitrides may be 100/mm². More specifically, the density of carbonitrides may be 50 to 100/mm².

The non-oriented electrical steel sheet according to an exemplary embodiment of the present invention may have a resistivity of 50 μΩ·cm or more. More specifically, the resistivity may be 53 μΩ·cm or more. Still more specifically, the resistivity may be 58 μΩ·cm or more. An upper limit thereof is not particularly limited, but may be 100 μΩ·cm or less.

The non-oriented electrical steel sheet according to an exemplary embodiment of the present invention has an improved magnetic permeability, and thus may be suitable for high-speed rotation. As a result, when the non-oriented electrical steel sheet is applied to a motor of a vehicle, the non-oriented electrical steel sheet may contribute to improving a mileage. Specifically, the non-oriented electrical steel sheet according to an exemplary embodiment of the present invention may have a magnetic permeability of 5,000 or more when measured at 30 A/m.

The non-oriented electrical steel sheet according to an exemplary embodiment of the present invention may have an average grain diameter of 50 to 100 μm. Within the above range, high-frequency iron loss is excellent. More specifically, the average grain diameter may be 75 to 95 μm.

As described above, in an exemplary embodiment of the present invention, an optimal alloy composition is suggested and carbonitrides are suppressed to a minimum, such that the magnetism may be improved. Specifically, an iron loss (W_{10/400}) and a magnetic flux density (B₅₀) of the non-oriented electrical steel sheet may be 12.5 W/kg or less and 1.65 T or more, respectively. The iron loss (W_{10/400}) may be iron loss when a magnetic flux density of 1.0 T is induced at a frequency of 400 HZ. The magnetic flux density (B₅₀) is a magnetic flux density induced from a magnetic field of 5,000 A/m. More specifically, the iron loss (W_{10/400}) and the magnetic flux density (B₅₀) of the non-oriented electrical steel sheet may be 11.0 to 12.5 W/kg and 1.65 to 1.70 T, respectively.

A method for manufacturing a non-oriented electrical steel sheet according to an exemplary embodiment of the present invention includes: manufacturing molten steel; bubbling the molten steel for 5 to 10 minutes; subjecting the molten steel to continuous casting to manufacture a slab; hot rolling the slab to manufacture a hot-rolled sheet; cold rolling the hot-rolled sheet to manufacture a cold-rolled sheet; and subjecting to the cold-rolled sheet to final annealing.

Hereinafter, each step will be described in detail.

First, molten steel is manufactured.

Since alloy components of the molten steel are described in the alloy components of the non-oriented electrical steel sheet described above, repeated descriptions will be omitted. The alloy components are not substantially changed in the manufacturing process of the non-oriented electrical steel sheet, and thus, the alloy components of the non-oriented electrical steel sheet and the molten steel are substantially the same.

Specifically, the molten steel may contain, by wt %: 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities, and may satisfy the following Expression 1.

$$0.02 \leq ( [ Ti ] + [ Nb ] ) \times [ Mo ] / ( [ C ] + [ N ] ) \leq 0.05 \qquad [ Expression 1 ]$$

(In Expression 1, [Ti], [Nb], [Mo], [C], and [N] represent contents (wt %) of Ti, Nb, Mo, C, and N, respectively.)

A manufacturing process of molten steel may be performed by a process known in the art. Mo, Ti, and Nb as the main elements in an exemplary embodiment of the present invention may be adjusted by adding Mo ferroalloy, Ti ferroalloy, Nb ferroalloy, and the like.

Next, the molten steel is bubbled for 5 to 10 minutes.

The bubbling in this case is bubbling after all alloy components are adjusted by adding raw materials such as Mo ferroalloy, Ti ferroalloy, Nb ferroalloy, and the like, and is distinguished from bubbling in a deoxidation or desulfurization process.

In addition, the bubbling may be bubbling after addition of raw materials such as Mo ferroalloy, Ti ferroalloy, and Nb ferroalloy, and may be distinguished from bubbling in the existing molten steel manufacturing process such as a deoxidation or desulfurization process in terms of using an inert gas and adding the inert gas at a flow rate of 5 Nm³ or more. The inert gas may be Ar gas. The flow rate may be 5 to 15 Nm³.

The bubbling may be performed for 5 to 10 minutes. By bubbling the molten steel, Mo may react with Ti and Nb sufficiently and may be completely dissolved, and the density of carbonitrides in the finally manufactured electrical steel sheet may be minimized. When the bubbling time is too short, the bubbling effects described above may be small. Even when the bubbling time is longer, it is difficult for Mo to react with Ti and Nb any more, and a problem may occur in terms of an increase in cost due to deterioration of productivity.

When the molten steel is not bubbled, carbonitrides of Ti and Nb exist in fine forms in the molten steel, and these carbonitrides are re-dissolved in a slab reheating step and more finely precipitated in a hot rolling process, and thus, the carbonitrides are not removed in hot-rolled sheet annealing and final annealing processes and remain as they are, which causes deterioration of magnetism in the finally manufactured steel sheet.

Next, the molten steel is subjected to continuous casting to manufacture a slab.

A manufacturing process of a slab may be performed by a process known in the art.

After the slab is manufactured, the slab may be heated. Specifically, the slab is may be charged into a heating furnace and heated to a temperature of 1,100° C. or higher and 1,250° C. or lower. When the slab heating temperature is too high, precipitates such as AlN and MnS present in the slab are re-dissolved and then finely precipitated during hot rolling and annealing, which may suppress grain growth and deteriorate magnetism.

Next, the slab is hot-rolled to manufacture a hot-rolled sheet. A thickness of the hot-rolled sheet may be 2 to 2.3 mm. In the step of manufacturing the hot-rolled sheet, a finish annealing temperature may be 800° C. or higher. Specifically, the finish annealing temperature may be 800 to 1,000° C. The hot-rolled sheet may be coiled at a temperature of 700° C. or lower.

After the step of manufacturing the hot-rolled sheet, a step of annealing the hot-rolled sheet may be further included. In this case, a hot-rolled sheet annealing temperature may be 850 to 1,150° C. When the hot-rolled sheet annealing temperature is too low, a structure is not grown or grows finely, and thus, it is not easy to obtain a texture favorable for magnetism during annealing after cold rolling. When the annealing temperature is too high, magnetic grains may be excessively grown, and surface defects of the sheet may be excessive. The hot-rolled sheet annealing is performed to increase an orientation favorable for magnetism, if necessary, and may be omitted. The annealed hot-rolled sheet may be pickled. More specifically, the hot-rolled sheet annealing temperature may be 950 to 1,150° C.

Next, the hot-rolled sheet is cold-rolled to manufacture a cold-rolled sheet. In this case, the hot-rolled sheet may be reduced by adjusting a reduction ratio to 70 to 85%. If necessary, the cold rolling step may include one cold rolling step or two or more cold rolling steps with intermediate annealing interposed therebetween. In this case, an intermediate annealing temperature may be 850 to 1,150° C.

Next, the cold-rolled sheet is subjected to final annealing. An annealing temperature in the process of annealing the cold-rolled sheet is not particularly limited as long as it is a temperature that is generally applied to a non-oriented electrical steel sheet. The iron loss of the non-oriented electrical steel sheet is closely related to a grain size, and thus the annealing temperature is suitably 8,500 to 1,000° C. In addition, the annealing may be performed in a short time with an annealing time of 100 seconds or shorter.

In the final annealing process, an average grain diameter may be 50 to 100 μm, and all (that is, 99% or more) of the processed structures formed in the previous cold rolling step may be recrystallized.

After the final annealing, an insulating coating film may be formed. The insulating coating film may be treated with organic, inorganic, and organic/inorganic composite coating films, and may be treated with other insulating coating agents.

Hereinafter, the present invention will be described in more detail with reference to Examples. However, these Examples are only for illustrating the present invention, and the present invention is not limited thereto.

### EXAMPLE 1

Molten steel was manufactured with the components including 0.002 wt % of S and a balance of Fe and inevitable impurities as shown in Table 1. Ar was injected at a flow rate of 10 Nm³ for the time summarized in Table 2, and the molten steel was bubbled, thereby manufacturing a slab. The slab was heated to 1,150° C. and subjected to hot finish rolling at 850° C. to manufacture a hot-rolled sheet having a sheet thickness of 2.0 mm. The hot-rolled sheet subjected to hot rolling was annealed at 1,100° C. for 4 minutes and then pickled. Thereafter, the hot-rolled sheet was cold-rolled to have a sheet thickness of 0.25 mm, and then the cold-rolled sheet was subjected to final annealing at each temperature shown in Table 2, thereby manufacturing a non-oriented electrical steel sheet. Five specimens of 60 mm in width×60 mm in length were cut, and an average value in a rolled direction and a vertical direction obtained using a single sheet tester was determined as an initial magnetic permeability of 30 A/m and was summarized in Table 2.

As for the density of carbonitrides, the number of carbonitrides having a particle diameter of 0.1 μm or less with respect to the TD plane in the specimen was observed with a scanning electron microscope (SEM), and the results were summarized. The average grain diameter was observed with an electron microscope, and the results thereof were summarized in Table 2.

The grain growth was calculated by soaking temperature (C) in final annealing×soaking time (min) in final annealing/average grain diameter (μm) and the results thereof were summarized in Table 2.

TABLE 1

| Steel | | | | | | | | | | | |
|---|---|---|---|---|---|---|---|---|---|---|---|
| type | | | | Resistivity | | | | | | Ti + Nb + | Value of |
| (wt %) | Si | Al | Mn | (μΩ · cm) | Mo | Ti | Nb | C | N | C + N | Expression 1 |
| 1 | 3.4 | 0.5 | 10.2 | 58 | 0.020 | 0.002 | 0.002 | 0.0025 | 0.0015 | 0.0080 | 0.030 |
| 2 | 2.5 | 0.3 | 1.0 | 51 | 0.030 | 0.002 | 0.002 | 0.0025 | 0.0015 | 0.0080 | 0.030 |
| 3 | 2.5 | 1.5 | 1.5 | 67 | 0.040 | 0.002 | 0.002 | 0.0025 | 0.0015 | 0.0080 | 0.030 |
| 4 | 3.4 | 0.5 | 0.2 | 58 | 0.090 | 0.002 | 0.002 | 0.0025 | 0.0015 | 0.0080 | 0.090 |
| 5 | 3.4 | 0.5 | 0.2 | 58 | 0.005 | 0.002 | 0.002 | 0.0025 | 0.0015 | 0.0080 | 0.005 |
| 6 | 3.2 | 0.5 | 0.2 | 56 | 0.007 | 0.004 | 0.004 | 0.0040 | 0.0025 | 0.0145 | 0.009 |
| 7 | 3.2 | 0.5 | 0.3 | 57 | 0.030 | 0.002 | 0.002 | 0.0025 | 0.0015 | 0.0080 | 0.030 |
| 8 | 3.2 | 0.5 | 0.3 | 57 | 0.025 | 0.002 | 0.002 | 0.0025 | 0.0015 | 0.0080 | 0.030 |
| 9 | 3.4 | 0.5 | 0.5 | 60 | 0.030 | 0.002 | 0.0055 | 0.0025 | 0.0015 | 0.0115 | 0.056 |
| 10 | 3.1 | 0.5 | 0.5 | 57 | 0.080 | 0.005 | 0.005 | 0.0040 | 0.0015 | 0.0155 | 0.145 |
| 11 | 3.1 | 0.7 | 0.5 | 59 | 0.020 | 0.0005 | 0.002 | 0.0025 | 0.0020 | 0.0070 | 0.011 |
| 12 | 3.3 | 0.7 | 0.2 | 60 | 0.070 | 0.006 | 0.004 | 0.0010 | 0.0015 | 0.0125 | 0.280 |
| 13 | 3.3 | 0.7 | 0.2 | 60 | 0.035 | 0.004 | 0.004 | 0.0040 | 0.0025 | 0.0145 | 0.037 |
| 14 | 3.6 | 0.5 | 0.2 | 61 | 0.060 | 0.004 | 0.004 | 0.0040 | 0.0055 | 0.0175 | 0.051 |
| 15 | 3.6 | 0.5 | 0.2 | 61 | 0.040 | 0.001 | 0.0008 | 0.0008 | 0.0025 | 0.0051 | 0.022 |

TABLE 2

| | | | | | Average | | | Magnetic | | |
|---|---|---|---|---|---|---|---|---|---|---|
| | Bubbling | Density of | Annealing | Annealing | grain | | Magnetic | flux | Iron | |
| Steel | time | carbonitrides | temperature | time | diameter | Grain | permeability | density | loss | |
| type | (min) | (/mm²) | (° C.) | (min) | (μm) | growth | (H = 30A/m) | (T) | (W/kg) | Reference |
| 1 | 7 | 80 | 950 | 1 | 95 | 10 | 6230 | 1.67 | 12.0 | Example |
| 2 | 8 | 88 | 950 | 1 | 78 | 21.2 | 5820 | 1.68 | 12.1 | Example |
| 3 | 8 | 89 | 950 | 1 | 85 | 11.2 | 5620 | 1.65 | 11.5 | Example |
| 4 | 9 | 120 | 950 | 1 | 55 | 17.3 | 3890 | 1.63 | 12.5 | Comparative |
| | | | | | | | | | | Example |
| 5 | 9 | 135 | 950 | 1 | 45 | 21.1 | 4520 | 1.64 | 12.8 | Comparative |
| | | | | | | | | | | Example |
| 6 | 7 | 140 | 950 | 1 | 62 | 15.3 | 4200 | 1.63 | 13.2 | Comparative |
| | | | | | | | | | | Example |
| 7 | 11 | 130 | 950 | 1 | 59 | 16.1 | 3870 | 1.64 | 12.9 | Comparative |
| | | | | | | | | | | Example |
| 8 | 8 | 90 | 950 | 1 | 72 | 13.2 | 5500 | 1.66 | 11.8 | Example |
| 9 | 3 | 155 | 950 | 1 | 61 | 15.6 | 3690 | 1.62 | 13.5 | Comparative |
| | | | | | | | | | | Example |
| 10 | 6 | 125 | 950 | 1 | 40 | 23.8 | 4780 | 1.63 | 13.3 | Comparative |
| | | | | | | | | | | Example |
| 11 | 9 | 107 | 950 | 1 | 61 | 15.6 | 4150 | 1.64 | 12.7 | Comparative |
| | | | | | | | | | | Example |
| 12 | 7 | 135 | 950 | 1 | 35 | 27.1 | 3580 | 1.62 | 13.7 | Comparative |
| | | | | | | | | | | Example |
| 13 | 7 | 95 | 950 | 1 | 82 | 11.6 | 5100 | 1.67 | 11.6 | Example |
| 14 | 10 | 150 | 950 | 1 | 51 | 18.6 | 4120 | 1.62 | 13.3 | Comparative |
| | | | | | | | | | | Example |
| 15 | 5 | 106 | 950 | 1 | 57 | 16.7 | 4360 | 1.64 | 12.6 | Comparative |
| | | | | | | | | | | Example |

As shown in Tables 1 and 2, in Examples in which Mo was appropriately added in comparison to Ti and Nb and the molten steel was appropriately bubbled, it could be confirmed that less carbonitrides were formed, and the magnetic permeability, magnetic flux density, and iron loss were excellent.

On the other hand, in Steep type 4, it could be confirmed that, since Mo was excessively added, Expression 1 was not satisfied, a compound of Mo and Si was formed, and fine carbonitrides were formed, and the magnetic permeability and magnetism were deteriorated.

In Steel types 5 and 6, it could be confirmed that the amount of Mo added was too small, and thus, Expression 1 was not satisfied, a large amount of carbonitrides was formed, and the magnetic permeability and magnetism were deteriorated.

In Steel type 7, it could be confirmed that the alloy components were appropriately added, but the bubbling time was too long, and thus, oxides in the slag were re-oxidized in the molten steel, a large amount of fine carbonitrides was formed, and the magnetic permeability and magnetism were deteriorated.

In Steep type 9, it could be confirmed that an excessive amount of Nb was added and the bubbling time was too short, and thus a large amount of carbonitrides was formed, and the magnetic permeability and magnetism were deteriorated.

In Steel types 10 to 12, it could be confirmed that Expression 1 was not satisfied, and thus, a large amount of carbonitrides was formed, and the magnetic permeability and magnetism were deteriorated.

In Steel type 14, it could be confirmed that an excessive amount of N was contained, and thus, a large amount of carbonitrides was formed, and the magnetic permeability and magnetism were deteriorated.

In Steel type 15, it could be confirmed that the amount of Nb and C added was small, and thus, a large amount of Mo-Si compound was formed, a large amount of carbonitrides was formed, and the magnetic permeability and magnetism were deteriorated.

The present invention is not limited to the exemplary embodiments, but may be manufactured in various different forms, and it will be apparent to those skilled in the art to which the present invention pertains that various modifications and alterations may be made without departing from the spirit or essential feature of the present invention. Therefore, it is to be understood that the exemplary embodiments described hereinabove are illustrative rather than restrictive in all aspects.

1. A non-oriented electrical steel sheet comprising, by wt %: 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities,
wherein the non-oriented electrical steel sheet satisfies the following Expression 1, and
a density of one or more of carbides, nitrides, and carbonitrides having a particle diameter of 0.1 μm or less is 100/mm² or less,
$$0.02 \leq ( [ Ti ] + [ Nb ] ) \times [ Mo ] / ( [ C ] + [ N ] ) \leq 0.05 \qquad [ Expression 1 ]$$
(in Expression 1, [Ti], [Nb], [Mo], [C], and [N] represent contents (wt %) of Ti, Nb, Mo, C, and N, respectively).

2. The non-oriented electrical steel sheet of claim 1, wherein:
the total amount of Ti, Nb, C, and N is 0.003 to 0.015 wt %.

3. The non-oriented electrical steel sheet of claim 1, further comprising one or more of 0.015 to 0.1 wt % of Sn, 0.015 to 0.1 wt % of Sb, and 0.005 to 0.05 wt % of P.

4. The non-oriented electrical steel sheet of claim 1, further comprising one or more of 0.01 wt % or less of Cu, 0.005 wt % or less of S, 0.002 wt % or less of B, 0.005 wt % or less of Mg, and 0.005 wt % or less of Zr.

5. The non-oriented electrical steel sheet of claim 1, wherein:
a resistivity is 50 μΩ·cm or more.

6. The non-oriented electrical steel sheet of claim 1, wherein:
an average grain diameter is 50 to 100 μm.

7. The non-oriented electrical steel sheet of claim 1, wherein:
a magnetic permeability is 5,000 or more when measured at 30 A/m.

8. A method for manufacturing a non-oriented electrical steel sheet, the method comprising:
manufacturing molten steel containing, by wt %, 2.0 to 3.8% of Si, 0.1 to 2.5% of Al, 0.1 to 2.5% of Mn, 0.01 to 0.08% of Mo, 0.0010 to 0.0050% of Ti, 0.0010 to 0.0050% of Nb, 0.0020 to 0.0060% of C, 0.0010 to 0.0050% of N, and a balance of Fe and inevitable impurities, and satisfying the following Expression 1;
bubbling the molten steel for 5 to 10 minutes;
subjecting the molten steel to continuous casting to manufacture a slab;
hot rolling the slab to manufacture a hot-rolled sheet;
cold rolling the hot-rolled sheet to manufacture a cold-rolled sheet; and
subjecting the cold-rolled sheet to final annealing,
$$0.02 \leq ( [ Ti ] + [ Nb ] ) \times [ Mo ] / ( [ C ] + [ N ] ) \leq 0.05 \qquad [ Expression 1 ]$$
(in Expression 1, [Ti], [Nb], [Mo], [C], and [N] represent contents (wt %) of Ti, Nb, Mo, C, and N, respectively).

9. The method of claim 8, wherein:
in the bubbling, an inert gas is used, and the inert gas is injected at a flow rate of 5 Nm³ or more.

10. The method of claim 8, wherein:
a grain growth calculated by the following Expression 2 is 10 to 15,
$$Grain growth = Soaking temperature ( °C . ) in final annealing \times Soaking time ( min ) in final annealing / Average grain diameter ( μm ) . \qquad [ Expression 2 ]$$
